(19) United States
(12) Patent Application Publication
(10) Pub. No.: US 2006/0127110 A1
(43) Pub. Date: Jun. 15, 2006

(54) In-situ optical sensor for measurement of toner concentration

(75) Inventors: Michael D. Borton, Ontario, NY (US); R. Enrique Viturro, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/011,697

(22) Filed: Dec. 14, 2004

(51) Int. Cl. G03G 15/08

(52) U.S. Cl. 399/30

(57) ABSTRACT

A developer apparatus for developing an image, including a sump for storing a quantity of developer material comprised of toner of a first color and carrier material, a donor member for developing the image with toner; an auger for transporting developer material within the sump; a toner concentration sensor for sensing toner concentration in the sump, the toner concentration sensor including a viewing window, in communication with developer material in the sump, an optical sensor for measuring reflected light off the developer material and a cleaning member coacting with the auger to clean the viewing window; and a system for generating a signal indicative of the toner concentration in the sump.

### CROSS-REFERENCE TO RELATED APPLICATIONS

Reference is made to commonly-assigned copending U.S. patent application Ser. No. 10/607,212 (Attorney Docket Number A3248-US-NP), entitled “LED COLOR SPECIFIC OPTICAL TONER CONCENTRATION SENSOR,” filed Jun. 26, 2003, by R. Enrique Viturro et al., copending U.S. patent application Ser. No. 10/012,442 (Attorney Docket Number A1424-US-NP), now U.S. Pat. No. 6,606,463 entitled “OPTICAL TONER CONCENTRATION SENSOR,” by Douglas A. Kreckel et al., copending U.S. patent application Ser. No. 10/607,290 (Attorney Docket Number A2421-US-NP), entitled “COMPENSATING OPTICAL MEASUREMENTS OF TONER CONCENTRATION FOR TONER IMPACTION,” filed Jun. 26, 2003, by Douglas A. Kreckel et al., and copending U.S. Patent Application Serial No. XX/XXX,XXX (Attorney Docket Number 20031341-US-NP), entitled “METHOD AND APPARATUS FOR MEASURING TONER CONCENTRATION,” filed Nov. 18, 2004 by Michael D. Borton et al., the disclosures of which are incorporated herein.

### BACKGROUND AND SUMMARY

This invention relates generally to a printing machine, and more particularly concerns an apparatus for measuring and controlling the concentration of toner in a development system of an electrophotographic printing machine.

In a typical electrophotographic printing process, a photoconductive member is charged to a substantially uniform potential so as to sensitize the surface thereof. The charged portion of the photoconductive member is exposed to a light image of an original document being reproduced. Exposure of the charged photoconductive member selectively dissipates the charges thereon in the irradiated areas. This records an electrostatic latent image on the photoconductive member corresponding to the informational areas contained within the original document. After the electrostatic latent image is recorded on the photoconductive member, the latent image is developed by bringing a developer material into contact therewith. Generally, the developer material comprises toner particles adhering triboelectrically to carrier granules. The toner particles are attracted from the carrier granules to the latent image forming a toner powder image on the photoconductive member. The toner powder image is then transferred from the photoconductive member to a copy sheet. The toner particles are heated to permanently affix the powder image to the copy sheet. After each transfer process, the toner remaining on the photoconductive member is cleaned by a cleaning device.

In a machine of the foregoing type, it is desirable to regulate the addition of toner particles to the developer material in order to ultimately control the triboelectric characteristics (tribo) of the developer material. However, control of the triboelectric characteristics of the developer material are generally considered to be a function of the toner concentration within the developer material. Therefore, for practical purposes, machines of the foregoing type usually attempt to control the concentration of toner particles in the developer material.

Toner tribo is a very “critical parameter” for development and transfer. Constant tribo would be an ideal case. Unfortunately, it varies with time and environmental changes. Since tribo is almost inversely proportional to Toner Concentration (TC) in a two component developer system, the tribo variation can be compensated for by the control of the toner concentration.

Toner Concentration is conventionally measured by a Toner Concentration (TC) sensor. The problems with TC sensors are that they are expensive, not very accurate, and rely on an indirect measurement technique which has poor signal to noise ratio.

There is provided a developer apparatus for developing an image, including a sump for storing a quantity of developer material comprised of toner of a first color and carrier material, a donor member for developing said image with toner; an auger for transporting developer material within said sump; a toner concentration sensor for sensing toner concentration in said sump, said toner concentration sensor including a viewing window, in communication with developer material in said sump, an optical sensor for measuring reflected light off said developer material and a cleaning member coacting with said auger to clean said viewing window; and a system for generating a signal indicative of the toner concentration in said sump.

### BRIEF DESCRIPTION OF THE DRAWINGS

FIG. 1 is a schematic elevational view of a typical electrophotographic printing machine utilizing the toner maintenance system therein.

FIG. 2 is a schematic elevational view of the development system utilizing the invention herein.

FIG. 3 is a schematic view of an embodiment of an optical percent TC sensing device illustrating the measuring process proposed in the invention herein.

FIG. 4 is an electrical schematic of an embodiment of the percent TC sensing device.

FIGS. 5-9 are graphs illustrating various experimental data of sensor output under different conditions.

FIG. 10 is a flow chart for processing sensor voltage output to derive a percent TC measurement.

### DETAILED DESCRIPTION

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

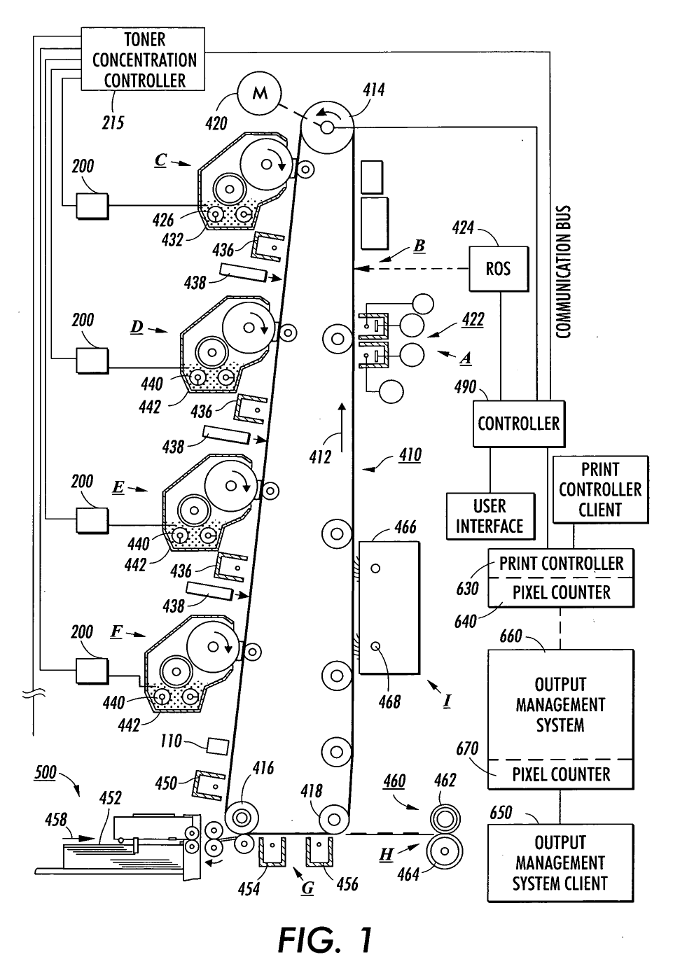

For a general understanding of the features of the present invention, reference is made to the drawings. In the drawings, like reference numerals have been used throughout to identify identical elements. FIG. 1 schematically depicts an electrophotographic printing machine incorporating the features of the present invention therein. It will become evident from the following discussion that the toner control apparatus of the present invention may be employed in a wide variety of devices and is not specifically limited in its application to the particular embodiment depicted herein.

Referring to FIG. 1, an Output Management System 660 may supply printing jobs to the Print Controller 630. Printing jobs may be submitted from the Output Management System Client 650 to the Output Management System 660. A pixel counter 670 is incorporated into the Output Management System 660 to count the number of pixels to be imaged with toner on each sheet or page of the job, for each color. The pixel count information is stored in the Output Management System memory. The Output Management System 660 submits job control information, including the pixel count data, and the printing job to the Print Controller 630. Job control information, including the pixel count data, and digital image data are communicated from the Print Controller 630 to the Controller 490.

The printing system preferably uses a charge retentive surface in the form of an Active Matrix (AMAT) photoreceptor belt 410 supported for movement in the direction indicated by arrow 412, for advancing sequentially through the various xerographic process stations. The belt is entrained about a drive roller 414, tension roller 416 and fixed roller 418 and the drive roller 414 is operatively connected to a drive motor 420 for effecting movement of the belt through the xerographic stations. A portion of belt 410 passes through charging station A where a corona generating device, indicated generally by the reference numeral 422, charges the photoconductive surface of photoreceptor belt 410 to a relatively high, substantially uniform, preferably negative potential.

Next, the charged portion of photoconductive surface is advanced through an imaging/exposure station B. At imaging/exposure station B, a controller, indicated generally by reference numeral 490, receives the image signals from Print Controller 630 representing the desired output image and processes these signals to convert them to signals transmitted to a laser based output scanning device, which causes the charge retentive surface to be discharged in accordance with the output from the scanning device. Preferably the scanning device is a laser Raster Output Scanner (ROS) 424. Alternatively, the ROS 424 could be replaced by other xerographic exposure devices such as LED arrays.

The photoreceptor belt 410, which is initially charged to a voltage V0, undergoes dark decay to a level equal to about −500 volts. When exposed at the exposure station B, it is discharged to a level equal to about −50 volts. Thus after exposure, the photoreceptor belt 410 contains a monopolar voltage profile of high and low voltages, the former corresponding to charged areas and the latter corresponding to discharged or background areas.

At a first development station C, developer structure, indicated generally by the reference numeral 432 utilizing a hybrid development system, the developer roller, better known as the donor roller, is powered by two developer fields (potentials across an air gap). The first field is the AC field which is used for toner cloud generation. The second field is the DC developer field which is used to control the amount of developed toner mass on the photoreceptor belt 410. The toner cloud causes charged toner particles to be attracted to the electrostatic latent image. Appropriate developer biasing is accomplished via a power supply. This type of system is a noncontact type in which only toner particles (black, for example) are attracted to the latent image and there is no mechanical contact between the photoreceptor belt 410 and a toner delivery device to disturb a previously developed, but unfixed, image. A toner concentration sensor 200 senses the toner concentration in the developer structure 432.

The developed but unfixed image is then transported past a second charging device 436 where the photoreceptor belt 410 and previously developed toner image areas are recharged to a predetermined level.

A second exposure/imaging is performed by device 438 which comprises a laser based output structure is utilized for selectively discharging the photoreceptor belt 410 on toned areas and/or bare areas, pursuant to the image to be developed with the second color toner. At this point, the photoreceptor belt 410 contains toned and untoned areas at relatively high voltage levels, and toned and untoned areas at relatively low voltage levels. These low voltage areas represent image areas which are developed using discharged area development (DAD). To this end, a negatively charged, developer material 440 comprising color toner is employed. The toner, which by way of example may be yellow, is contained in a developer housing structure 442 disposed at a second developer station D and is presented to the latent images on the photoreceptor belt 410 by way of a second developer system. A power supply (not shown) serves to electrically bias the developer structure to a level effective to develop the discharged image areas with negatively charged yellow toner particles. Further, a toner concentration sensor 200 senses the toner concentration in the developer housing structure 442.

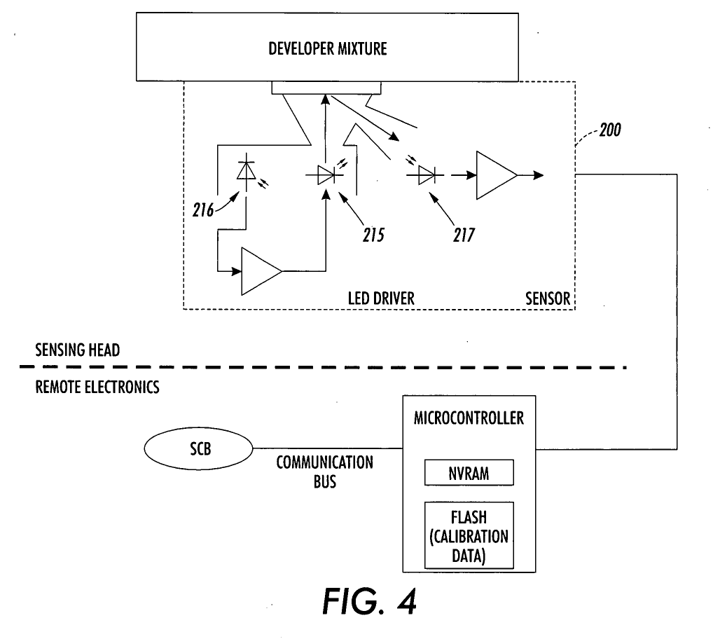

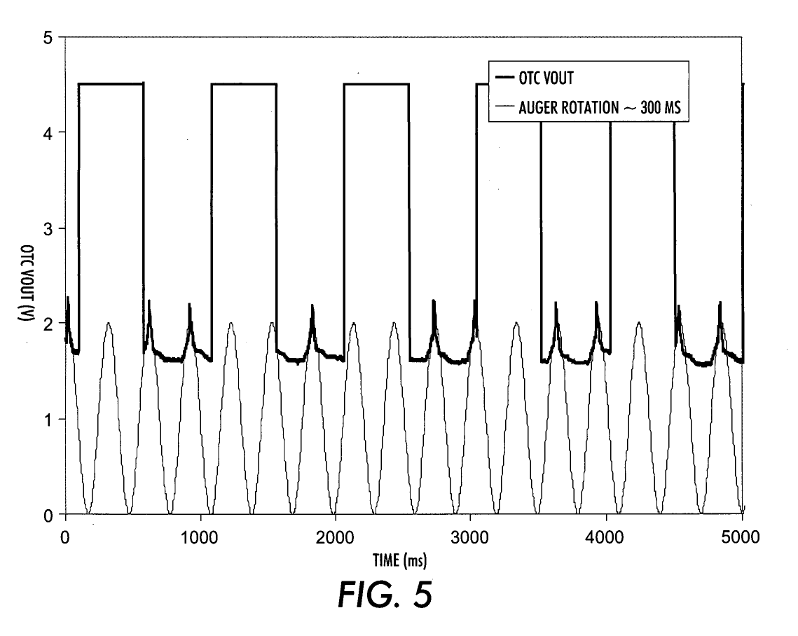

The above procedure is repeated for a third image for a third suitable color toner such as magenta (station E) and for a fourth image and suitable color toner such as cyan (station F). The exposure control scheme described below may be utilized for these subsequent imaging steps. In this manner a full color composite toner image is developed on the photoreceptor belt 410. In addition, a mass sensor 110 measures developed mass per unit area. Although only one mass sensor 110 is shown in FIG. 4, there may be more than one mass sensor 110.

To the extent to which some toner charge is totally neutralized, or the polarity reversed, thereby causing the composite image developed on the photoreceptor belt 410 to consist of both positive and negative toner, a negative pre-transfer dicorotron member 450 is provided to condition the toner for effective transfer to a substrate using positive corona discharge.

Subsequent to image development a sheet of support material 452 is moved into contact with the toner images at transfer station G. The sheet of support material 452 is advanced to transfer station G by a sheet feeding apparatus 500, described in detail below. The sheet of support material 452 is then brought into contact with photoconductive surface of photoreceptor belt 410 in a timed sequence so that the toner powder image developed thereon contacts the advancing sheet of support material 452 at transfer station G.

Transfer station G includes a transfer dicorotron 454 which sprays positive ions onto the backside of sheet 452. This attracts the negatively charged toner powder images from the photoreceptor belt 410 to sheet 452. A detack dicorotron 456 is provided for facilitating stripping of the sheets from the photoreceptor belt 410.

After transfer, the sheet of support material 452 continues to move, in the direction of arrow 458, onto a conveyor (not shown) which advances the sheet to fusing station H. Fusing station H includes a fuser assembly, indicated generally by the reference numeral 460, which permanently affixes the transferred powder image to sheet 452. Preferably, fuser assembly 460 comprises a heated fuser roller 462 and a backup or pressure roller 464. Sheet 452 passes between fuser roller 462 and backup roller 464 with the toner powder image contacting fuser roller 462. In this manner, the toner powder images are permanently affixed to sheet 452. After fusing, a chute, not shown, guides the advancing sheet 452 to a catch tray, stacker, finisher or other output device (not shown), for subsequent removal from the printing machine by the operator.

After the sheet of support material 452 is separated from photoconductive surface of photoreceptor belt 410, the residual toner particles carried by the non-image areas on the photoconductive surface are removed therefrom. These particles are removed at cleaning station I using a cleaning brush or plural brush structure contained in a housing 466. The cleaning brush 468 or brushes 468 are engaged after the composite toner image is transferred to a sheet. Once the photoreceptor belt 410 is cleaned the brushes 468 are retracted utilizing a device incorporating a clutch (not shown) so that the next imaging and development cycle can begin.

Controller 490 regulates the various printer functions. The controller 490 is preferably a programmable controller, which controls printer functions hereinbefore described. The controller 490 may provide a comparison count of the copy sheets, the number of documents being recirculated, the number of copy sheets selected by the operator, time delays, jam corrections, etc. The control of all of the exemplary systems heretofore described may be accomplished by conventional control switch inputs from the printing machine consoles selected by an operator. Conventional sheet path sensors or switches may be utilized to keep track of the position of the document and the copy sheets.

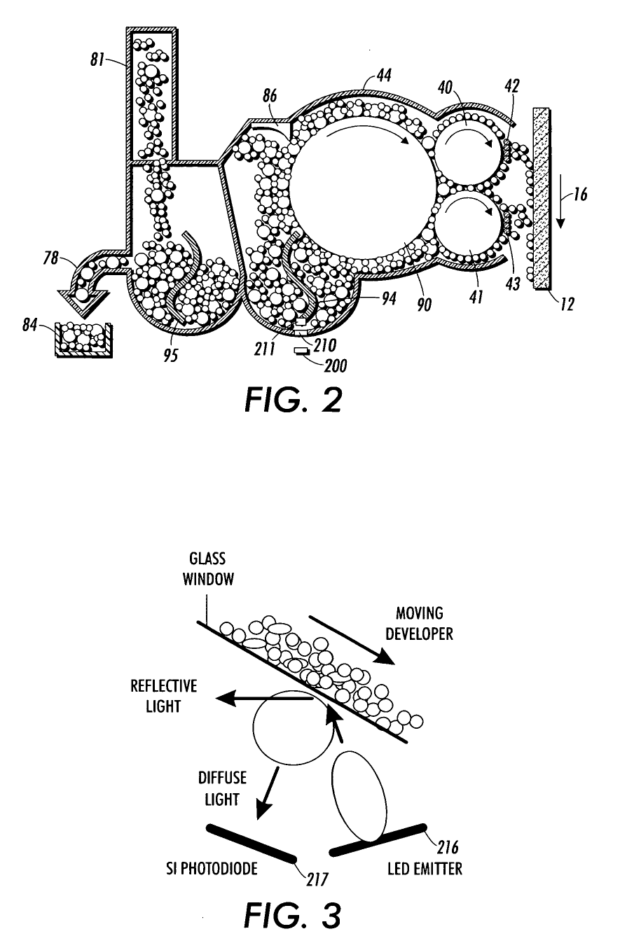

Now referring to the developer station, for simplicity one developer station will be described in detail, since each developer station is substantially identical. In FIG. 2, donor rollers 40 and 41 are shown rotating in the direction of arrow 68, i.e. the ‘against’ direction. Similarly, the magnetic roller 90 can be rotated in either the ‘with’ or ‘against’ direction relative to the direction of motion of donor rollers 40 and 41. In FIG. 2, magnetic roller 90 is shown rotating in the direction of arrow 92, i.e. the ‘with’ direction. Developer unit also has electrode wires 42 and 43 which are disposed in the space between the photoconductive belt 10 and donor rollers 40 and 41. A pair of electrode wires 42 and 43 are shown extending in a direction substantially parallel to the longitudinal axis of the donor rollers 40 and 41. The electrode wires 42 are made from one or more thin (i.e. 50 to 100μ diameter) wires (e.g. made of stainless steel or tungsten) which are closely spaced from donor rollers 40 and 41.

With continued reference to FIG. 2, an alternating electrical bias is applied to the electrode wires 42 and 43 by an AC voltage source (not shown). The applied AC establishes an alternating electrostatic field between the electrode wires 42 and 43 and the donor rollers 40 and 41 which is effective in detaching toner from the surface of the donor rollers 40 and 41 and forming a toner cloud about the wires, the height of the cloud being such as not to be substantially in contact with the photoconductive belt 10. The magnitude of the AC voltage is on the order of 200 to 500 volts peak at a frequency ranging from about 3 kHz to about 10 kHz. A DC bias supply (not shown) which applies approximately 300 volts to donor roller 40 establishes an electrostatic field between photoconductive surface of belt 10 and donor rollers 40 and 41 for attracting the detached toner particles from the cloud surrounding the electrode wires 42 and 43 to the latent image recorded on the photoconductive surface 12.

Magnetic roller 90 meters a constant quantity of toner having a substantially constant charge onto donor rollers 40 and 41. This insures that the donor roller provides a constant amount of toner having a substantially constant charge as maintained by the present invention in the development gap.

A DC bias supply which applies approximately 100 volts to magnetic roller 90 establishes an electrostatic field between magnetic roller 46 and donor rollers 40 and 41 so that an electrostatic field is established between the donor rollers 40 and 41 and the magnetic roller 90 which causes toner particles to be attracted from the magnetic roller 90 to the donor rollers 40 and 41.

An optical sensor 200 is positioned adjacent to transparent viewing window 210 which is in visual communication with housing 44. Preferably, transparent viewing window 210 is positioned in a place where the developer material is well mixed and flowing near auger 94 supplying the magnetic roller 90 thereby a toner concentration representative of the overall housing 44 can be obtained. Auger 95 mixes new developer material received from developer dispenser 81. Housing 44 also includes a trickle port 78 for allowing old developer material to leave the development system into waste container 84.

The optical sensor 200 is positioned adjacent the surface of transparent viewing window 210. The toner on transparent viewing window 210 is illuminated. The optical sensor 200 generates proportional electrical signals in response to electromagnetic energy, reflected off of the transparent viewing window 210 and toner on transparent viewing window 210, is received by the optical sensor 200. FIG. 3 illustrates the measuring process. In response to the signals, the amount of toner concentration can be calculated.

The optical sensor 200 detects specular and diffuse electromagnetic energy reflected off developer material on transparent viewing window 210. FIG. 4 illustrates a diagrammatic scheme of an optical percent TC sensor. In this implementation, the sensor shows a LED emitter 218, a photodiode 216 used for LED intensity feedback loop control, and a photodiode 217, positioned at 300 to 600 preferably 45° optical path, used for detection of the reflectivity of the developer. Additionally, the optical sensor 200 may be of a type employed in an Extended Toner Area Coverage Sensor (ETACS) Infrared Densitometer (IRD) such as an optimized color densitometers (OCD), which measures material density located on a substrate by detecting and analyzing both specular and diffuse electromagnetic energy signal reflected off of the density of material located on the substrate as described in U.S. Pat. Nos. 4,989,985 and 5,519,497, which is hereby incorporated by reference. The optical sensor 200 is positioned adjacent the surface of transparent viewing window 210. The toner on transparent viewing window 210 is illuminated. The optical sensor 200 generates proportional electrical signals in response to electromagnetic energy, reflected off of the developer material on transparent viewing window 210, is received by the optical sensor 200. In response to the signals, the amount of toner concentration can be calculated by toner concentration controller 215. Auger 85 has a cleaning member 211 which cleans viewing window 210 which enhances the accuracy of the TC measurement by refreshing the window. Preferably, cleaning member 211 is a magnetic member which forms a brush from developer material in the housing.

Toner concentration controller 215 determines the toner concentration measurement based upon output responses of the sensor in relation to disturbance effects of the auger rotating at a predefined velocity. Applicants believe that the disturbance in the developer flow is caused by the moving developer brush/auger and the void in the flow that results when it passes in front of the sensor.

FIGS. 5-7 illustrate test data representing toner concentration measurements. FIG. 4 depicts typical voltage response of the sensor at −50% duty cycle and nominal auger speed (200 rpm) with lower graph auger rotation period to =300 ms. FIG. 5 is an enlarged graph of the typical voltage response of the sensor at ˜50% duty cycle of FIG. 4, it shows that the combined effect of Magnet—Auger rotation on the developer flow takes approximately ⅔ of the period. Applicants have found that the magnet/flight disturbance decreases the value of the detected reflectivity signal.

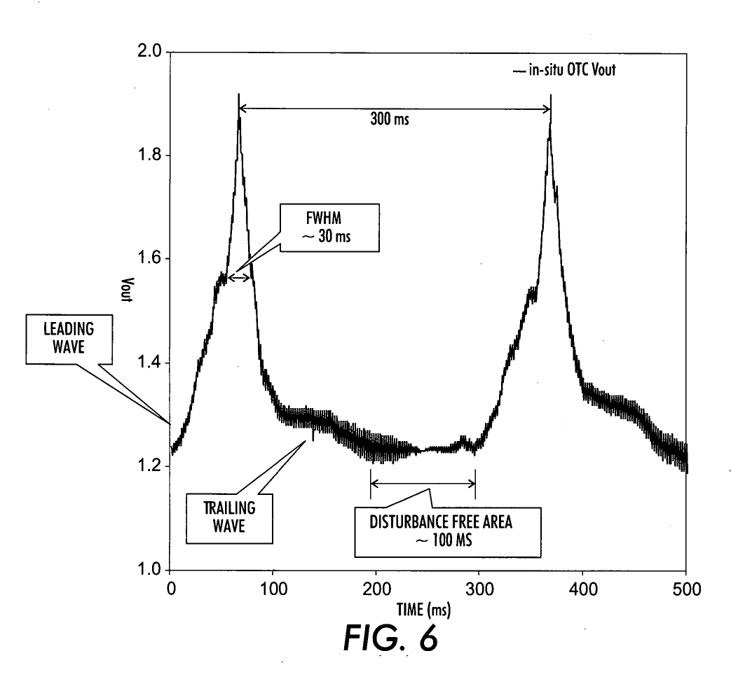

FIG. 6 shows the experimental voltage output (Vout) of the sensor under operating conditions. Four different regions are identified: leading wave, caused by the extension of developer brush; peak disturbance, caused by the magnet; trailing wave: developer brush effect extended by the flight effect on flow; and the undisturbed region, which is ˜⅓ of the cycle.

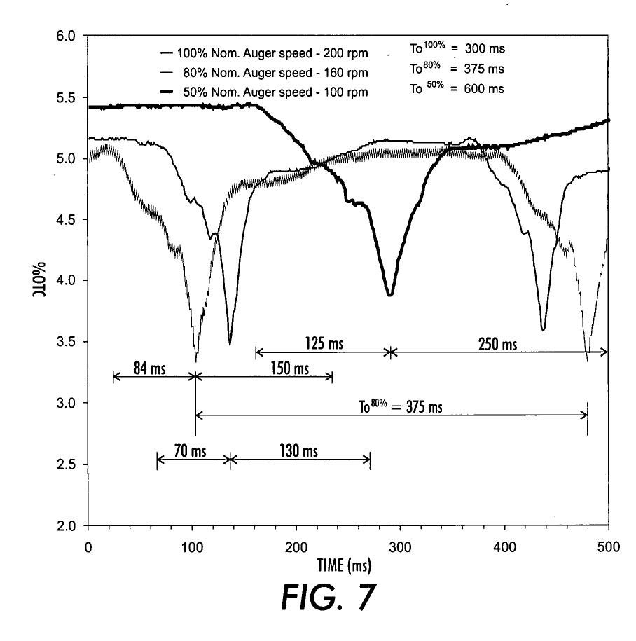

FIG. 7 illustrates sensor reading output to % TC. Results of experiments for several toners indicate that the calibration of the sensor Vout can be given by expressions of the type
% TC=A*(Vout)²+B*(Vout)+C
where A, B, and C are experimentally determined coefficients. In the case of sensing a reduced % TC range, the quadratic coefficient A may be neglected. In those cases the expression is reduced to
% TC=D*(Vout)+F.

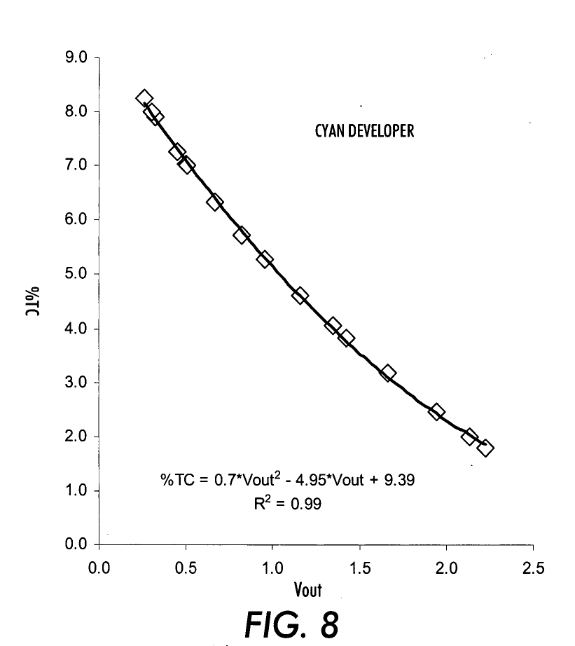

FIG. 8 illustrates experimental results for a cyan toner based developer, and a sensor whose active output region is in the 0 to 2.5 volt range, the coefficients A, B, and C are −0.7, 4.95 and 9.39, respectively.

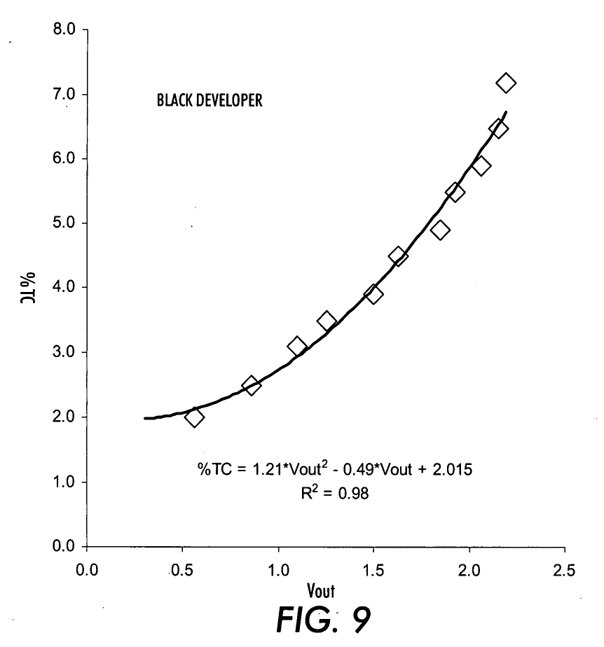

FIG. 9 illustrates experimental results for a black toner based developer, and the coefficients A, B, and C are 1.21, −0.49 and 2.015, respectively. The reason why the curve for black is reversed is because increasing black toner % TC decreases the reflectivity of the developer, whereas increasing colored toner % TC increases the reflectivity of the developer.

The Toner Concentration Controller 215 may be configured to accept input from one or more sensors 200.

Several schemes for processing of Vout in presence of flow disturbances are possible. A particular implementation consists of using a mathematical filtering procedure to eliminate the effect of the disturbances. The main idea is to use a mathematical filter to remove the effect of the disturbances produced by the magnet or cleaning blade and the auger flight. FIG. 6 illustrates the signal output of sensor 200 under operating conditions.

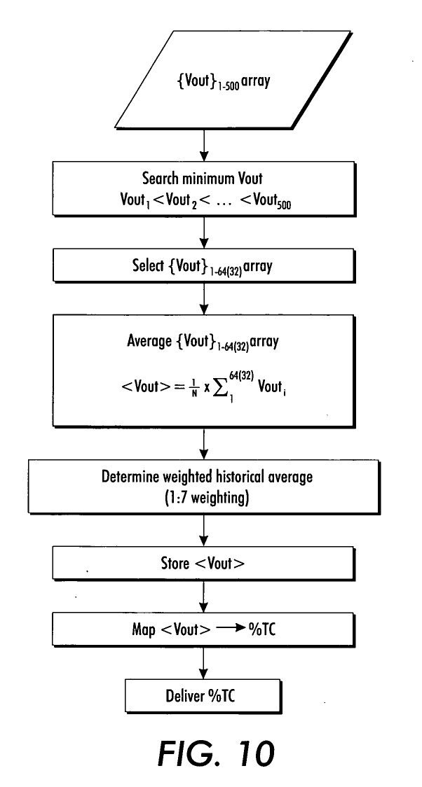

FIG. 10 is a flow chart illustrating a method for processing Vout. A particular implementation of a mathematical filter defined here as Procedure #1 consists of the following steps:

1) Sample the output of the sensor approximately every 1/500th of the auger rotational period for at least one period.

2) Find the lowest N data points in the collected data.

3) Average the N data points.

4) Perform a weighted average of the current result with the historical average.

5) Map this value to toner concentration based on the characteristic response for each color.

6) Deliver updated TC value to Process Controller.

Another example of a mathematical filter defined here as Procedure #2, and implemented in the sensor 200 controller firmware, consists of the following steps:

1) Sample the output of the sensor approximately every 1/500th of the auger rotational period for at least one period.

2) Find the lowest N data point in the collected data.

3) Average the N data points prior to the detected minimum.

4) Perform a weighted average of the current result with the historical average.

5) Map this value to toner concentration based on the characteristic response for each color.

6) Deliver updated TC value to Process Controller.

It is, therefore, apparent that there has been provided in accordance with the present invention, that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

1. A developer apparatus for developing an image, comprising:
a sump for storing a quantity of developer material comprised of toner of a first color and carrier material, a donor member for developing said image with toner;
an auger for transporting developer material within said sump; a toner concentration sensor for sensing toner concentration in said sump, said toner concentration sensor including a viewing window, in communication with developer material in said sump, an optical sensor for measuring reflected light off said developer material, said auger includes an auger blade, disposed adjacent to said viewing window, for transporting developer material across said viewing window, said auger blade including a cleaning member for cleaning developer material oft said viewing window; and
a toner concentration controller having means for correlating measurements from said optical sensor to a toner concentration measurement and wherein said toner concentration controller determines said toner concentration measurement as a function of output voltage responses in relation to toner flow disturbance effects.

2. (canceled)

3. The developer apparatus of claim 1, wherein said cleaning member includes a magnetic member for forming a magnetic brush that contacts said viewing window.

4. The developer apparatus of claim 3, further comprising means for rotating said auger at a said predefined velocity.

5. (canceled)

6. (canceled)

7. The developer apparatus of claim 1, wherein said optical sensor including a light source and a light detector.

8. The developer apparatus of claim 7, wherein said light source comprises a LED and said light detector comprises a Si photodiode.

9. The developer apparatus of claim 1, wherein said toner concentration controller adapted to receive a signal from said sensor and to generate an “Add Toner” signal to replenish toner in said sump to maintain a predefined toner concentration.

10. The developer apparatus according to claim 1, wherein said viewing window comprises a glass, quartz or plastic window.

11. A printing machine having a developer apparatus for developing an image, comprising;
a sump for storing a quantity of developer material comprised of toner of a first color and carrier material,
a donor member for developing said image with toner;
an auger for transporting developer material within said sump; a toner concentration sensor for sensing toner concentration in said sump, said toner concentration sensor including a viewing window, in communication with developer material in said sump, an optical sensor for measuring reflected light off said developer material, said auger includes an auger blade, disposed adjacent to said viewing window, for transporting developer material across said viewing window, said auger blade including a cleaning member for cleaning developer material off said viewing window; and
a toner concentration controller having means for correlating measurements from said optical sensor to a toner concentration measurement and wherein said toner concentration controller determines said toner concentration measurement as a function of output voltage responses in relation to toner flow disturbance effects.

12. (canceled)

13. The developer apparatus of claim 11, wherein said cleaning member includes a magnetic member for forming a magnetic brush that contacts said viewing window.

14. The developer apparatus of claim 13, further comprising means for rotating said auger at said predefined velocity.

15. (canceled)

16. (canceled)

17. The developer apparatus of claim 11, wherein said optical sensor including a light source and a light detector

18. The developer apparatus of claim 17, wherein said light source comprises a LED and said light detector comprises a Si photodiode.

19. The developer apparatus of claim 11, wherein said toner concentration controller adapted to receive a signal from said sensor and to generate an “Add Toner” signal to replenish toner in said sump to maintain a predefine toner concentration.

20. The developer apparatus according to claim 11, wherein said viewing window comprises a glass, quartz or plastic window.
